(19) United States
(12) Patent Application Publication
(10) Pub. No.: US 2024/0128069 A1
(43) Pub. Date: Apr. 18, 2024

(54) Method of Performing Ms/Ms of High Intensity Ion Beams Using a Bandpass Filtering Collision Cell to Enhance Mass Spectrometry Robustness

(71) Applicant: DH Technologies Development Pte. Ltd., Singapore (SG)

(72) Inventors: Mircea GUNA, Toronto (CA); Andrei SONOC, Richmond Hill (CA)

(73) Assignee: DH Technologies Development Pte. Ltd., Singapore (SG)

(21) Appl. No.: 18/276,609

(22) PCT Filed: Feb. 8, 2022
(86) PCT No.: PCT/IB2022/051118

§ 371 Date: Aug. 9, 2023

Related U.S. Application Data
(60) Provisional application No. 63/148,099, filed on Feb. 10, 2021.

(51) Int. Cl. H01J 49/00; H01J 49/06

(52) U.S. Cl. CPC H01J 49/005; H01J 49/0031; H01J 49/062

(57) ABSTRACT

In one aspect, a method of performing mass spectrometry is disclosed, which comprises introducing a plurality of ions into a mass spectrometer, selecting a portion of the precursor ions having m/z ratios within a first desired range to provide a plurality of precursor ions, causing fragmentation of at least a portion of the precursor ions to generate a plurality of product ions, selecting a portion of the product ions having m/z ratios within a second desired range, and performing mass analysis of the selected productions.

### RELATED APPLICATIONS

The present application claims priority to U.S. Provisional Application No. 63/148,099 filed on Feb. 10, 2021, entitled “Method of Performing MS/MS of High Intensity Ion Beams Using a Bandpass Filtering Collision Cell to Enhance Mass Spectrometry Robustness,” which is incorporated herein by reference in its entirety.

### BACKGROUND

The present disclosure is generally directed to a mass spectrometer as well as methods for performing mass spectrometry, e.g., mass spectrometers in which SRM (selected reaction monitoring) is employed for elucidating the structure of an analyte.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

One of the main causes of signal and resolution degradation in mass spectrometers is due to transmission of ions other than the analytes of interest to a mass analyzer and deposition of such ions on inner surfaces of the mass analyzer, which can lead to charging of those surfaces and concomitant degradation of performance. To alleviate this problem, in some mass spectrometers, ions are filtered prior to their introduction to the first mass analyzer.

Selected reaction monitoring (SRM) is a method used in tandem mass spectrometry in which a precursor ion of a particular mass is selected in a first stage of a tandem mass spectrometer and an ion product of a fragmentation reaction of the precursor ion is selected in a second stage of the mass spectrometer for detection. Although the use of ion filtering in the first stage can help with lowering the problem of contamination of various components of the mass spectrometer positioned upstream of the second stage, the product ions generated due to fragmentation of the precursor ions can be deposited on a mass analyzer employed to detect the product ions and hence cause a performance degradation.

Accordingly, there is a need for enhanced mass spectrometers and methods for performing mass spectrometry, and particularly for such mass spectrometers that can be employed for conducting SRM of an analyte.

### SUMMARY

In one aspect, a method of performing mass spectrometry is disclosed, which comprises introducing a plurality of ions into a mass spectrometer, selecting a portion of the precursor ions having m/z ratios within a first desired range to provide a plurality of precursor ions, causing fragmentation of at least a portion of the precursor ions to generate a plurality of product ions, selecting a portion of the product ions having m/z ratios within a second desired range, and performing mass analysis of the selected product ions.

In some embodiments, the selection of a portion of the ions received by the ion source can be accomplished by introducing the precursor ions into a first mass filter and the selection of a portion of the product ions for mass analysis can be accomplished by introducing the product ions into a second mass filter. The mass filters can be implemented in a variety of different ways. By way of example, in some embodiments, a mass filter can include a plurality of rods arranged in a multipole configuration to which RF and/or DC voltages can be applied to ensure that ions having desired m/z ratios pass through the mass filter while ions having other m/z ratios are inhibited from passage through the mass filter, e.g., by being subjected to unstable trajectories.

In some embodiments, the multipole configuration can be a quadrupole configuration. Further in some embodiments, the application of RF and/or DC voltages to one or more of the rods results in generating an electromagnetic field within a mass filter for facilitating the selection of a portion of the ions received from the ion source or the product ions.

In a related aspect, a mass spectrometer is disclosed, which includes an orifice for receiving a plurality of ions from an ion source, a first bandpass mass filter for receiving at least a portion of the ions, where the first bandpass mass filter is configured for selecting a portion of the ions having m/z ratios within a first desired range or at a desired value to provide a plurality of precursor ions. The mass spectrometer can further include a collision cell disposed downstream of the first bandpass filter for receiving at least a portion of the precursor ions and cause fragmentation of at least a portion thereof to generate a plurality of product ions. The mass spectrometer can further include a second bandpass mass filter for receiving at least a portion of the product ions, where the second bandpass mass filter is configured to select a portion of the product ions having m/z ratios within a selected range or value. The selected product ions can then be mass analyzed, e.g., via a downstream mass analyzer to generate a mass spectrum thereof.

In some embodiments, the collision cell and the second bandpass mass filter are positioned in the same chamber. Such a chamber can be maintained at a pressure in a range of about 1 to about 10 mTorr to facilitate the fragmentation of at least a portion of the precursor ions. Alternatively, the collision cell and the second bandpass mass filter can be positioned in separate chambers, where the second bandpass mass filter is disposed downstream of the collision cell and is configured to select a portion of the product ions that exhibit m/z ratios within a desired range or at a desired value.

A mass analyzer can be positioned downstream of the second bandpass mass filter to receive at least a portion of the product ions selected by the second bandpass mass filter and provide a mass analysis thereof. A variety of mass analyzers can be employed. For example, in some embodiments, the mass analyzer can be a quadrupole mass analyzer.

In some embodiments, any of the first and the second bandpass mass filter includes a plurality of rods that are arranged according to a multipole configuration, e.g., a quadrupole configuration, and are configured for application of RF and/or DC voltages thereto for generating an electromagnetic field within the bandpass mass filter for facilitating the selection of the ions received from the ion source and/or the product ions.

In some embodiments, the first bandpass mass filter has an m/z bandwidth in a range of about 0.7 to about 25 and the second bandpass mass filter has an m/z bandwidth in a range of about 10 to about 200. In some embodiments, the second bandpass mass filter has an m/z bandwidth in a range of about 200 to about 400.

In some embodiments, an ion guide is positioned upstream of the first bandpass mass filter for receiving ions passing through the orifice and providing focusing of the ions. The ion guide can include a plurality of rods that are arranged in a multi-rod configuration and are configured for application of RF and/or DC voltages thereto for generating an electromagnetic field for focusing the ions.

Further understanding of various aspects of the present teachings can be obtained with reference to the following detailed description and the associated drawings, which are described briefly below.

### BRIEF DESCRIPTION OF DRAWINGS

FIG. 1 is a flow chart according to an embodiment of the present teachings, depicting various steps in a method of performing mass spectrometry,

FIG. 2 is a mass spectrometer according to an embodiment of the present teachings,

FIG. 3 is an example of application of DC and RF voltages to the rods of a mass filter employed in the mass spectrometer of FIG. 2 for selecting a portion of the product ions based on their m/z ratios, and

FIG. 4 is a schematic view of a mass spectrometer according to another embodiment.

### DETAILED DESCRIPTION

The present teachings are generally related to a method of performing mass spectrometry, and mass spectrometers in which such a method can be implemented. In some embodiments, a plurality of precursor ions are fragmented, e.g., via collisions with a background gas (e.g., N₂), and a portion of the product ions having m/z ratios within a desired range are selected for mass analysis.

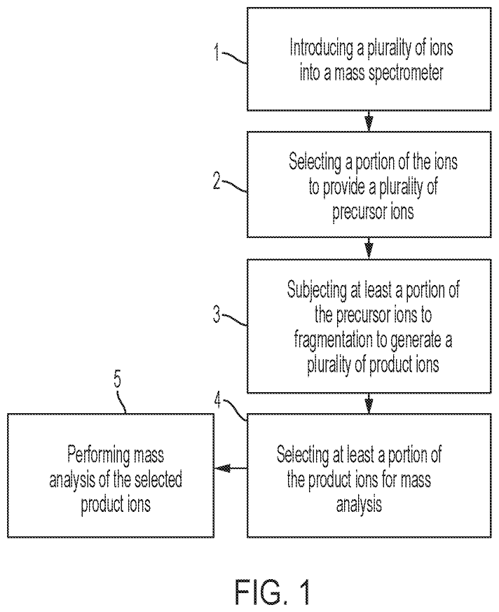

With reference to flow chart of FIG. 1, a method according to an embodiment of the present teachings for performing mass spectrometry includes introducing a plurality of ions into a mass spectrometer (step 1), and selecting, e.g., via a mass filter, a portion of those ions having m/z ratios at a desired value or within a desired range to provide a plurality of precursor ions (step 2), and causing fragmentation of at least a portion of the selected precursor ions (step 3) (e.g., via collisional dissociation) to provide a plurality of product ions. The method further comprises selecting a portion of the product ions having m/z ratios within a desired range (step 4), and performing mass analysis of the selected product ions (step 5).

A method according to the present teachings can be implemented in a variety of mass spectrometers and using a variety of techniques for ion fragmentation.

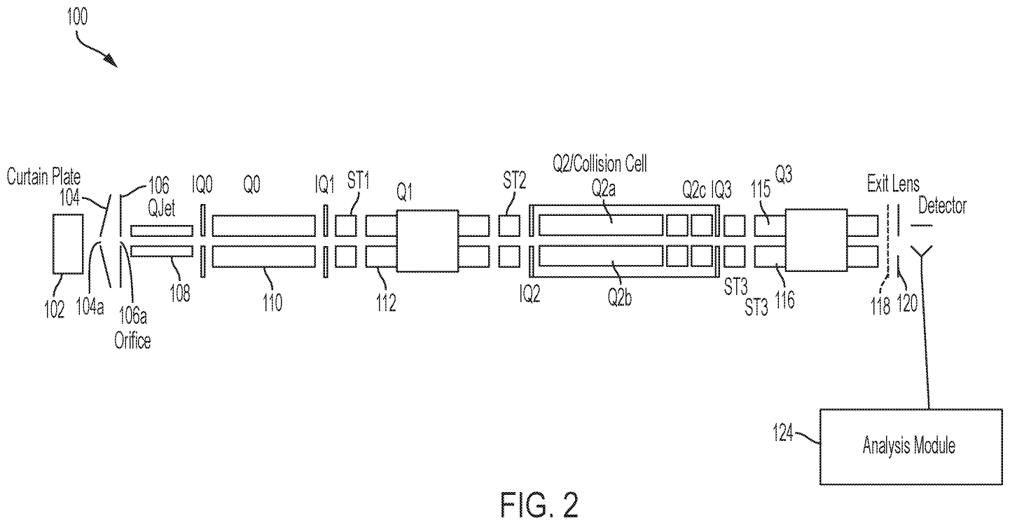

By way of example, FIG. 2 schematically depicts a mass spectrometer 100, which includes an ion source 102 for generating a plurality of ions. A variety of ion sources can be employed in the practice of the present teachings. Some examples of suitable ion sources can include, without limitation, an electrospray ionization device, a nebulizer assisted electrospray device, a chemical ionization device, a nebulizer assisted atomization device, a chemical ionization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, among others.

The generated ions pass through an orifice 104a of a curtain plate 104 and an orifice 106a of a orifice plate 106, which is positioned downstream of the curtain plate and is separated from the curtain plate such that a gas curtain chamber is formed between the orifice and the curtain plate. A curtain gas supply (not shown) can provide a curtain gas flow (e.g., of N₂) between the curtain plate 104 and the orifice plate 106 to help keep the downstream sections of the mass spectrometer clean by de-clustering and evacuating large neutral particles. The curtain chamber can be maintained at an elevated pressure (e.g., a pressure greater than the atmospheric pressure) while the downstream sections of the mass spectrometer can be maintained at one or more selected pressures via evacuation through one or more vacuum pumps (not shown).

In this embodiment, the ions passing through the orifices of the curtain plate and the orifice plate are received by a QJet ion guide, which comprises four rods 108 (two of which are visible in this figure) that are arranged in a quadrupole configuration to form an ion beam for transmission to downstream components of the mass spectrometer. In use, the QJet ion guide can be employed to capture and focus the ions received through the opening of the orifice plate 106 using a combination of gas dynamics and radio frequency fields.

The ion beam exits the QJet ion guide and is focused via a lens IQ0 into a subsequent ion guide Q0, which includes four rods 110 (two of which are visible in this figure) that are arranged in a quadrupole configuration and to which RF and/or DC voltages can be applied for focusing the ions as they pass through the Q0 ion guide. In other embodiments, other multipole configurations, such as a hexapole or an octupole configuration, can be utilized. In some embodiments, the pressure of the Q0 ion guide can be maintained, for example, in a range of about 3 mTorr to about 10 mTorr. In this embodiment, the Q0 ion guide includes four rods 109 arranged in a quadrupole configuration and to which RF and/or DC voltages can be applied for generating an electromagnetic field for focusing the ions passing through the ion guide.

The Q0 ion guide delivers the ions, via an ion lens IQ1, and a stubby lens ST1, which functions as a Brubaker lens, to a downstream ion guide Q1, which is configured to function as a mass filter. In this embodiment, the ion guide Q1 includes four rods 112 (two of which are visible in this figure) that are arranged in a quadrupole configuration (though in other embodiments, other multipole configurations can also be employed) and to which RF and/or DC voltages can be applied. In some embodiments, the Q1 ion guide can be situated in a vacuum chamber that can be maintained, for example, at a pressure in a range of about 0.6 to about 4×10⁻⁵ Torr.

More specifically, in this embodiment, the quadrupole rod set Q1 can be operated as a conventional transmission RF/DC quadrupole mass filter for selecting ions having an m/z value of interest or m/z values within a range of interest. By way of example, the quadrupole rod set Q1 can be provided with RF/DC voltages suitable for operation in a mass-resolving mode. For example, parameters of applied RF and DC voltages can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1.

In this embodiment, the ions selected by the Q1 mass filter are focused via a stubby lens and an ion lens IQ2 into a collision cell Q2. In this embodiment, the collision cell Q2 includes a pressurized compartment that can be maintained, e.g., at a pressure in a range of about 1 mTorr to about 10 mTorr, though other pressures can also be used for this or other purposes. A suitable collision gas (e.g., nitrogen, argon, helium, etc.) can be provided by way of a gas inlet (not shown) to fragment at least a portion of the ions received by the collision cell.

In this embodiment, the collision cell Q2 includes three sets of rods Q2a, Q2b and Q2c, that are disposed in series relative to one another. In this embodiment, the Q2a rod set includes four rods (two of which are visible in the figure) that are arranged in a quadrupole configuration and provide a passageway for transit of ions therethrough. The ions can undergo collisions as they pass through the passageway between the Q2a rod set, where the collisions cause fragmentation of at least a portion of the ions received by the collision cell (herein also referred to as precursor ions) to generate a plurality of product ions. The application of RF voltages to the Q2a rod set can provide an electromagnetic field for radially confining the precursor and/or product ions. The application of DC voltage to the Q2a can provide the potential drop, relative to the Q1 rod offset, required to accelerate the precursor ions into the collision cell and induce fragmentation. In some embodiments, the Q2a DC offset voltage, relative to the Q1 rod offset voltage, can be in a range of about 5 to about 150 V.

In this embodiment, each of the Q2B and Q2C rod sets includes four rods arranged in a quadrupole configuration. The Q2B rod set function as a mass filter for selecting product ions having m/z ratios within a desired range (or a desired value). More specifically, the quadrupole rod set Q2B can be provided with RF/DC voltages suitable for operating in a mass-resolving mode. For example, parameters of applied RF and DC voltages can be selected so that Q2B would establish a transmission window for product ions having m/z values within a desired range. The application of RF and/or DC voltages to the Q2c rod set can provide an electromagnetic field for radially confining the precursor and/or product ions as well. The DC voltage applied to the Q2c would be 0.5 to 1V more attractive than the DC rod offset applied to the Q2b rod set.

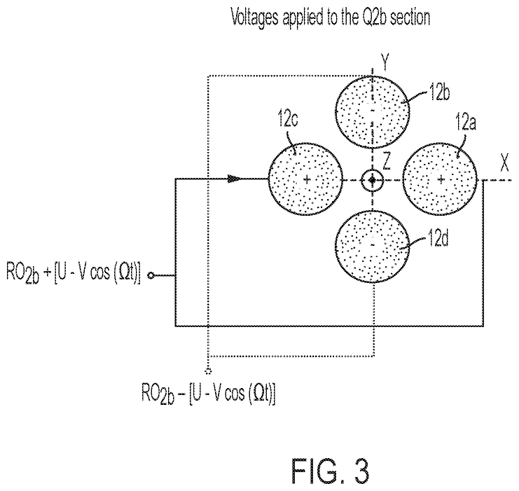

FIG. 3 schematically depicts an example of RF voltages that can be applied to the Q2B rods, which are numbered as 12a, 12b, 12c, and 12d. More specifically, the voltage applied across the rods 12b, and 12c can be defined in accordance with the following Eq. (1) and the voltage applied across the rods 12a and 12d can be defined in according with the following Eq. (2):

RO_{2b}−[U−V cos(Ωt)] Eq. (1)

RO_{2b}+[U−V cos(Ωt)] Eq. (2)

where,
RO_{2b} represents the DC rod offset voltage set in general in a range of about 0.5 to 1V more attractive than the DC rod offset applied to the Q2a rod set,
U represents the amplitude of resolving DC voltage,
V represents the amplitude of the RF voltage, and
Ω represents angular frequency of the RF voltage, where Ω=2πf, where f represents the frequency of the RF voltage.

In some embodiments, the resolving DC (i.e., U) voltage can be in a range of about 1 to about 500 V, the amplitude of the RF voltages (i.e., V) can be in a range of about 10 V p-p to about 3000 Vp-p and the frequency of the RF voltages (i.e., f) can be in a range of about 300 kHz to about 5 MHz. For a given U, V, and Ω, the overall ion motion can result in a stable trajectory for certain ions having an m/z at a particular value, or in a particular range. Such ions can pass through the quadrupole mass analyzer while other ions can experience unstable trajectories and hence be prevented from passage through the quadrupole mass analyzer.

The product ions selected by the Q2b rod are additionally collisionally cooled in the Q2c section then exit the collision cell Q2 and are focused by an ion lens IQ3 and a stubby lens ST3 into a downstream quadrupole mass analyzer Q3 via an inlet 115 thereof.

The quadrupole mass analyzer Q3 includes four rods 116 that are arranged relative to one another in a quadrupole configuration and to which RF and/or DC voltages can be applied in a manner known in the art to provide mass analysis of the product ions.

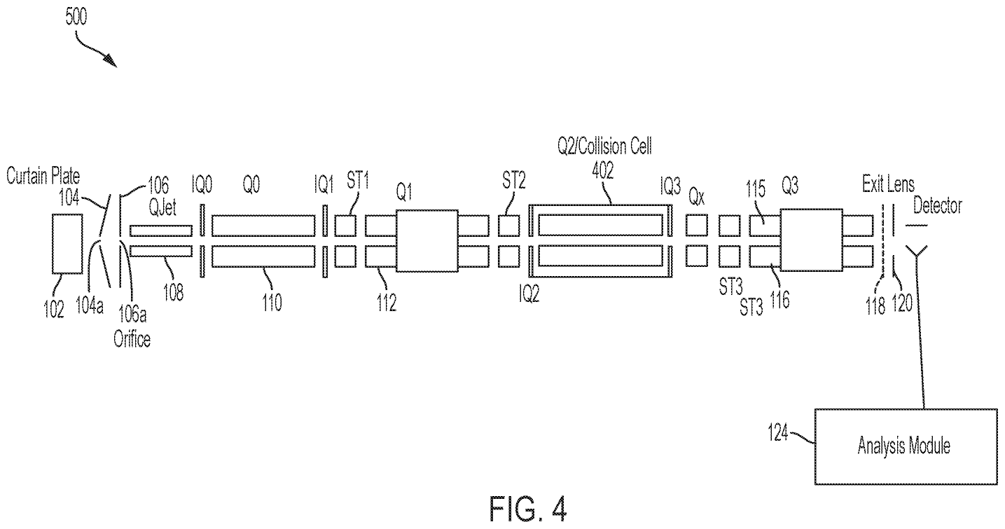

Although in the above embodiment, mass filters are disposed in the collision cell chamber, in other embodiments, one or more mass filters can be disposed downstream of the collision cell in one or more separate chambers. By way of example, FIG. 4 schematically depicts an example of a mass spectrometer 500 according to such an embodiment, which is similar to the above embodiment except that it includes a bandpass mass filter Qx that is disposed downstream of the collision cell in a separate chamber than the chamber in which the rods of the collision cell are positioned.

The product ions generated by the collision cell 402 are received by a downstream quadrupole mass analyzer Q3 via a stubby lens, which functions to focus the product ions into the quadrupole mass analyzer. The quadrupole mass analyzer Q3 includes four rods that are arranged relative to one another in a quadrupole configuration and to which RF and/or DC voltages can be applied in a manner known in the art to provide mass analysis of the product ions. The ions transmitted by the Q3 mass analyzer are detected by the ion detector 120 that is part of the analyzer module 124, after passing through the exit lenses 118 and 120.

The present teachings provide a number of advantages relative to conventional mass spectrometers. By way of example, in a mass spectrometer according to the present teachings can exhibit a lower contamination in the components, such as mass analyzers and/or ion optics, that are disposed downstream of a collision cell.

Those having ordinary skill in the art will appreciate that various changes to the above embodiments can be made without departing from the scope of the invention.

What is claimed is:

1. A method of performing mass spectrometry, comprising:
introducing a plurality of precursor ions into a mass spectrometer,
selecting a portion of said precursor ions having m/z ratios within a first desired range,
causing fragmentation of at least a portion of said selected precursor ions to generate a plurality of product ions,
selecting a portion of said product ions having m/z ratios within a second desired range, and
performing mass analysis of said selected product ions.

2. The method of claim 1, wherein the step of selecting a portion of said precursor ions comprises introducing said precursor ions into a first mass filter.

3. The method of claim 2, wherein the step of selecting a portion of said product ions comprises introducing the product ions into a second mass filter.

4. The method of claim 3, wherein any of said first and second mass filter comprises a plurality of rods arranged in a multipole configuration.

5. The method of claim 4, wherein said rods are configured for application of any DC and/or RF voltage thereto for generating an electromagnetic field within said mass filter for facilitating selection of said portions of any of the precursor and product ions.

6. The method of claim 4, wherein said multipole configuration comprises a quadrupole configuration.

7. A mass spectrometer, comprising:
an orifice for receiving a plurality of precursor ions from an ion source,
a first bandpass mass filter for receiving at least a portion of said ions, said first bandpass mass filter being configured for selecting a portion of said precursor ions having m/z ratios within a first desired range,
a collision cell disposed downstream of said first bandpass mass filter for receiving at least a portion of said selected precursor ions to cause fragmentation of at least a portion thereof to generate a plurality of product ions, and
a second bandpass mass filter for receiving at least a portion of said product ions, said second bandpass mass filter being configured to select a portion of said product ions having m/z ratios within a second desired range.

8. The mass spectrometer of claim 7, wherein said collision cell and said second bandpass mass filter are positioned in the same chamber.

9. The mass spectrometer of claim 7, wherein said collision cell and said second bandpass mass filter are positioned in separate chambers.

10. The mass spectrometer of claim 7, further comprising a mass analyzer disposed downstream of said second bandpass mass filter to receive at least a portion of said selected product ions and provide mass analysis thereof.

11. The mass spectrometer of claim 10, wherein said mass analyzer comprises a quadrupole mass analyzer.

12. The mass spectrometer of claim 7, wherein any of said first and second bandpass mass filter comprises a plurality of rods arranged in a multipole configuration and configured for application of any of an RF and/or DC voltage thereto for generating an electromagnetic field within said bandpass mass filter for facilitating selection of said portions of any of the precursor and product ions.

13. The mass spectrometer of claim 12, wherein said multipole configuration comprises a quadrupole configuration.

14. The mass spectrometer of claim 7, wherein said first bandpass mass filter has an m/z bandwidth in a range of about 0.7 to about 25.

15. The mass spectrometer of claim 7, wherein said second bandpass mass filter has an m/z bandwidth in a range of about 10 to about 200.

16. The mass spectrometer of claim 7, wherein said second bandpass mass filter has an m/z bandwidth in a range of about 200 to about 400.

17. The mass spectrometer of claim 7, further comprising an ion guide positioned upstream of said first bandpass mass filter for receiving ions passing through said orifice and provide focusing of said ions.

18. The mass spectrometer of claim 17, wherein said ion guide comprises a plurality of rods arranged in a multi-rod configuration and configured for application of RF and/or DC voltages thereto for generating an electromagnetic field for focusing said ions.
